(19) United States
(12) Patent Application Publication
(10) Pub. No.: US 2026/0077418 A1
(43) Pub. Date: Mar. 19, 2026

(54) WELDING CONTROL METHOD, WELDING SYSTEM, NON-TRANSITORY COMPUTER READABLE MEDIUM STORING WELDING CONTROL PROGRAM, AND MULTI-LAYER OVERLAY WELDING METHOD

(71) Applicant: Kabushiki Kaisha Kobe Seiko Sho (Kobe Steel, Ltd.), Kobe-shi (JP)

(72) Inventors: Keito ISHIZAKI, Kobe-shi (JP); Junichi KAWATA, Kobe-shi (JP); Kohei MATSUSHIMA, Kobe-shi (JP)

(73) Assignee: Kabushiki Kaisha Kobe Seiko Sho (Kobe Steel, Ltd.), Kobe-shi (JP)

(21) Appl. No.: 19/269,163

(22) Filed: Jul. 15, 2025

(30) Foreign Application Priority Data
Sep. 13, 2024 (JP) 2024-159293

(51) Int. Cl. B23K 9/04; B23K 31/12; B23K 37/02; G06T 7/00

(52) U.S. Cl. CPC B23K 9/044; B23K 31/12; B23K 37/0229; G06T 7/0002; G06T 2207/30164

(57) ABSTRACT

A welding control method for multi-layer overlay welding performed using a welding system including at least a welding robot, a robot control device that controls the welding robot, a camera, and a data processing device that processes image data obtained from the camera, includes: determining welding conditions at any position on a welding start side on a workpiece using the welding robot; starting welding of a first layer based on the welding conditions, receiving the image data obtained from the camera by the data processing device during welding of the first layer, outputting a feature value of the image data to the robot control device, and controlling at least one of the welding conditions based on the feature value by the robot control device; and determining teaching point information for second and subsequent layers based on work information obtained by control in the welding of the first layer.

### BACKGROUND OF THE INVENTION

### 1. Field of the Invention

The present invention relates to a welding control method, a welding system, a non-transitory computer readable medium storing a welding control program, and a multi-layer overlay welding method.

### 2. Description of the Related Art

In the field of manufacturing such as shipbuilding, bridge construction, and architecture, as the automatic welding technology providing high welding quality, a technology has been known which controls welding based on weld images using a visual sensor (hereinafter also referred to as a “camera”). For example, Japanese Unexamined Patent Application Publication No. 2018-192524 discloses a welding control technology that, even with a variation in image luminance, fluctuation of arc or molten pool, or presence or absence of sputter or variation in the position of the sputter, enables accurate image recognition by controlling a welding mechanism that, for the purpose of enabling accurate image recognition, gives images acquired by a camera to a machine learning model as input, obtains status related information output from the machine learning model, and performs arc welding based on the obtained status related information.

### SUMMARY OF THE INVENTION

In this manner, welding can be automatically performed with high accuracy using a camera. However, in order to perform automatic welding with high accuracy, welding conditions serving as a reference need to be set to appropriate values automatically. Particularly, in multi-layer overlay welding, multiple layers are formed by multiple weld passes, thus welding conditions equal in number to the weld passes need to be automatically set. In related art, when a condition is automatically set, teaching or sensing of a welding position is performed, but the greater the size of a workpiece (hereinafter also referred to as a “work”), the longer the weld length, and the number of points where teaching or sensing is performed also increases, thus the time required for teaching or sensing increases. Thus, a function capable of reducing the time for condition setting and automatically setting an appropriate welding condition is called for in automatic multi-layer overlay welding. This function is more important for a larger work.

Japanese Unexamined Patent Application Publication No. 2018-192524 discloses the welding control method after a condition is set; however, the above-mentioned function is not taken into consideration.

The present invention has been devised in view of the above-described problem, and it is an object of the invention to provide a welding control method, a welding system, a non-transitory computer readable medium storing a welding control program, and a multi-layer overlay welding method that, in automatic multi-layer overlay welding are capable of reducing the time for condition setting and automatically setting an appropriate welding condition.

The present invention includes the following configurations.
(1) A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device; and
determining, after the welding of the first layer, teaching point information for second and subsequent layers before welding of the second layer based on work information obtained by control in the welding of the first layer.
(2) A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device;
determining, after the welding of the first layer, teaching point information for a second layer before welding of the second layer based on work information obtained by control in the welding of the first layer; and
determining, for the second and subsequent layers, before welding of (n+1)th layer, at least one of teaching point information of the (n+1)th layer, a welding condition in the teaching point information, or a layer pattern in the teaching point information based on work information obtained by control in welding of nth layer, the n being a natural number greater than 1.
(3) A welding system for performing multi-layer overlay welding, comprising at least a welding robot, a robot control device that controls the welding robot, a camera, and a data processing device that processes image data obtained from the camera,
wherein the welding robot determines, before welding, welding conditions at any position on a welding start side on a workpiece, and
starts welding of a first layer based on the welding conditions,
the data processing device receives input of image data obtained from the camera during welding of the first layer, and outputs a feature value of the image data to the robot control device,
the robot control device controls at least one of the welding conditions based on the feature value, and
the robot control device determines, after the welding of the first layer, teaching point information for second and subsequent layers before welding of the second layer based on work information obtained by control in the welding of the first layer.
(4) A non-transitory computer readable medium storing a welding control program for multi-layer overlay welding causing a robot control device for controlling a welding robot to execute a process comprising:
causing the welding robot to weld a first layer based on welding conditions determined at any position on a welding start side on a workpiece before welding;
controlling at least one of the welding conditions based on a feature value of image data, obtained based on the image data obtained from a camera during the welding of the first layer, the image data including a molten pool, a welding wire and an arc; and
determining, after the welding of the first layer, teaching point information for second and subsequent layers before welding of the second layer based on work information obtained by control in the welding of the first layer.
(5) A multi-layer overlay welding method performed using a welding system including at least a welding robot, a robot control device that controls the welding robot, a camera, and a data processing device that processes image data obtained from the camera, the multi-layer overlay welding method comprising:
determining, before welding, welding conditions at any position on a welding start side on a workpiece;
starting welding of the first layer based on the welding conditions, and controlling at least one of the welding conditions based on a feature value of image data, obtained based on the image data obtained from the camera during the welding of the first layer, the image data including a molten pool, a welding wire and an arc; and
determining, after the welding of the first layer, teaching point information for second and subsequent layers before welding of the second layer based on work information obtained by control in the welding of the first layer.

According to the present invention, in automatic multi-layer overlay welding, the time for condition setting can be reduced, and an appropriate welding condition can be automatically set.

### BRIEF DESCRIPTION OF THE DRAWINGS

FIG. 1 is a schematic view illustrating a configuration example of a welding system according to the present embodiment;

FIG. 2 is a flowchart illustrating a welding control process example according to the present embodiment;

FIG. 3 is a perspective view for explaining a placement position of an image capturing device according to the present embodiment;

FIG. 4 is an image illustrating a weld image captured by an image capturing device when horizontal position welding is performed;

FIG. 5 is a block diagram illustrating a configuration example of a data processing device according to the present embodiment;

FIG. 6 is an explanatory view illustrating an example of a screen used for teaching work;

FIG. 7 is an explanatory view illustrating a specific example of a weld image obtained by horizontal position welding, and an example of welding information in the weld image;

FIG. 8 is a conceptual view illustrating a deviation amount from a weld line according to the present embodiment; and

FIG. 9 is a conceptual view illustrating a method of addition/update of a teaching point according to the present embodiment.

### DESCRIPTION OF THE PREFERRED EMBODIMENTS

Hereinafter, a welding system according to an embodiment of the present invention will be described with reference to the drawings. Note that in the drawings, the same components are labelled with the same reference number, thereby showing a correspondence relationship between the drawings. The welding system according to the present invention is applicable to a portable welding robot, but is not limited to the configuration of the present embodiment. For example, the welding system is applicable to a six-axis welding robot, or an automatic welding apparatus having a driving unit such as a carriage. In the present embodiment, horizontal position one-side welding is selected as an example, but without being limited to this, the welding method, and welding position are not particularly limited.

In the present embodiment, as described below, image capturing is performed so that at least a molten pool during welding is included in image data, and feature points related to a molten pool, a welding wire and an arc are extracted. A method of extracting the feature points is not particularly limited, and in the present embodiment, the feature points are extracted using the data processing device described later.

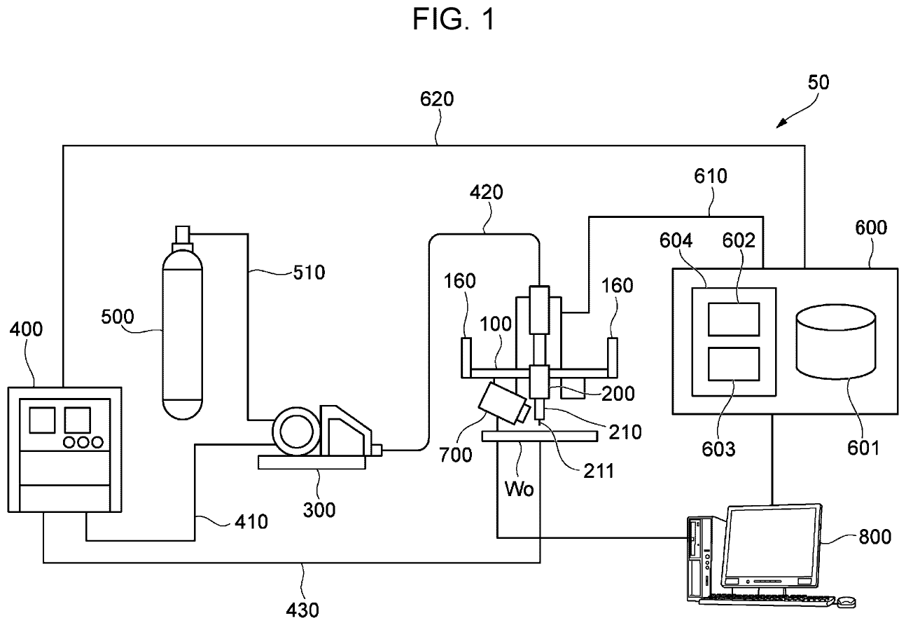

FIG. 1 is a schematic view illustrating a configuration example of a welding system according to the present embodiment. A welding system 50 includes a portable welding robot 100, a feeding device 300, a welding power source 400, a shielding gas supply source 500, a robot control device 600, an image capturing device 700, and a data processing device 800. Note that as described above, when the features of the present embodiment are applied to a six-axis welding robot, and an automatic welding apparatus having a driving unit such as a carriage, a further configuration may be included according to these configurations. The components included in the welding system 50 are communicably connected by various wired or wireless communication methods. The communication methods herein are not limited to one method, and multiple communication methods may be combined and connected.

### Robot Control Device

The robot control device 600 is connected to the portable welding robot 100 by a robot control cable 610, and is connected to the welding power source 400 by a power source control cable 620.

The robot control device 600 includes a data holding section 601 that holds teaching data that defines, in advance, the operation pattern, welding start position, welding end position, work condition, welding conditions, parameter table (hereinafter also referred to as “condition DB”) of the portable welding robot 100, and transmits command information to the portable welding robot 100 and the welding power source 400 as a command based on the teaching data to control the operation of the portable welding robot 100 and the welding conditions.

The robot control device 600 may include: a groove shape information calculating unit 602 that calculates, before welding, groove shape information from detection data obtained by performing sensing such as touch sensing; and a welding condition acquiring unit 603 that performs layer design, and sets or corrects, and acquires the welding conditions in the above-mentioned teaching data for each pass based on at least one of the groove shape information or the condition DB. The groove shape information calculating unit 602 and the welding condition acquiring unit 603 constitute a control unit 604. The control unit 604 is constituted using e.g., a central processing unit (CPU), a micro processing unit (MPU), a digital signal processor (DSP), or a field programmable gate array (FPGA). Note that in the present embodiment, from the viewpoint of efficiency, welding condition setting is applied by utilizing the most appropriate sensing; however, without being limited to this, for example, direct teaching is performed, and welding condition setting may be made. In the present invention, the sensing position or the teaching position (hereinafter also referred to as the “teaching position” or the “teaching point”) of an initial layer (hereinafter also referred to as a “first layer”) is any position on the welding start side as mentioned below. Note that any position on the welding start side indicates the welding start position or the vicinity of the welding start position. In the present invention, from the viewpoint of the accuracy of the groove shape information, the welding condition at the welding start position is set; however, the welding conditions at the welding start position may be set based on the groove shape information of the vicinity of the welding start position. The layer design and the welding condition setting for the second and subsequent passes according to the present invention will be described below.

The layer design refers to determining appropriate number of layers and number of passes for a given groove. The number of layers indicates the number of weld beads overlapped in the thickness direction. In the layer design of multi-layer overlay welding, in general, the major premise is that the layer height per layer is set constant. Thus, layer design is performed based on the groove shape information, and the welding conditions may be set or corrected based on calculated layer design information. Here, the layer design information includes the number of layers, the number of passes, the layer height (≈the height of one pass), and the welding conditions are determined on the basis of at least the value of a calculated layer height. For example, when the gap is found to be greater at the welding end position than at the welding start position by sensing, the gap width increases as the welding progresses, thus the amount of welding needs to be increased to achieve a constant layer height. The welding conditions related to the amount of welding include a wire feed speed and a welding speed, and these welding conditions may be set or corrected based on the groove shape information and the layer design information.

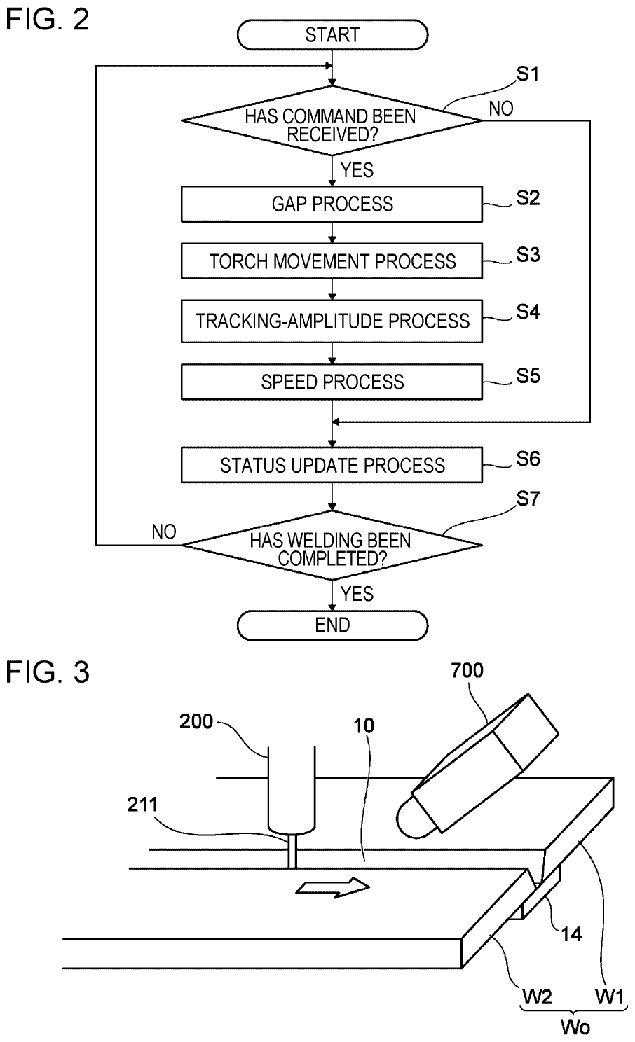

FIG. 2 is a flowchart illustrating a welding control process example according to the present embodiment. In the present embodiment, the robot control device 600 starts welding with the welding conditions in the teaching data which has been set or corrected based on sensing. The image capturing device 700 captures an image so that the image data includes the molten pool during welding. The data processing device 800 which has obtained the captured image data extracts feature points. The robot control device 600 then receives correction signals to various processes as command information (hereinafter also referred to as a “command”) from the information of the feature points (S1). The robot control device 600 sequentially executes control such as a gap process (S2), a torch movement process (S3), a tracking-amplitude process (S4), and a speed process (S5) which will be each described below. The robot control device 600 performs the process for each control according to the correction signals received during welding, and subsequently, outputs information on the status update of various control conditions to the data processing device 800 (S6). The above-mentioned processes (S1 to S6) are repeated until target welding is completed (S7).

The welding power source 400 supplies electric power to a welding wire 211 serving as a consumable electrode and a work Wo by a command from the robot control device 600, thereby generating an arc between the welding wire 211 and the work Wo. The electric power from the welding power source 400 is sent to the feeding device 300 through a power cable 410, and sent from the feeding device 300 to a welding torch (hereinafter referred to as a “torch”) 200 through a conduit tube 420. The electric power from the welding power source 400 is supplied to the welding wire 211 through a contact chip at the distal end of the torch 200. Note that the current at the time of a welding work may be a direct current or an alternating current, and its waveform is not particularly limited. Thus, the current may be a pulse of a square wave or a triangle wave and the like.

For example, the welding power source 400 allows the power cable 410 to be connected to the torch 200 side as a positive electrode, and allows a power cable 430 to be connected to the work Wo as a negative electrode. Note that the above is a case where welding is performed with reverse polarity, and when welding is performed with straight polarity, the power cable of the positive electrode should be connected to the work Wo, and the power cable of the negative electrode should be connected to the torch 200.

### Shielding Gas Supply Source

The shielding gas supply source 500 includes a container in which a shielding gas is enclosed, and an incidental member such as a valve. A shielding gas is delivered from the shielding gas supply source 500 to the feeding device 300 through a gas tube 510. The shielding gas delivered to the feeding device 300 is delivered to the torch 200 through the conduit tube 420. The shielding gas delivered to the torch 200 flows within the torch 200, and is guided to a nozzle 210, then ejected from the distal end side of the torch 200. As the shielding gas used in the present embodiment, e.g., argon (Ar), carbon dioxide (CO2) or a mixture of these gases may be used.

In the conduit tube 420 according to the present embodiment, a conductive path serving as a power cable is formed on the sheath side of the tube, a protective tube to protect the welding wire 211 is disposed inside the tube, and a flow path for the shielding gas is formed. However, the conduit tube 420 is not limited to this, and for example, it is possible to use what is obtained by bundling a power supply cable and a shielding gas supply hose around the protective tube at the center to feed the welding wire 211 to the torch 200. Alternatively, for example, the tube for delivering the welding wire 211 and the shielding gas, and the power cable may be individually installed.

### Feeding Device

The feeding device 300 feeds the welding wire 211, and delivers it to the torch 200. The welding wire 211 fed by the feeding device 300 is not limited to a specific one, and selected by the properties of the work Wo and the welding form, and for example, a solid wire or a flux-cored wire is used. The line diameter of the welding wire is not particularly limited, and in the present embodiment, the upper limit may be 1.6 mm, and the lower limit may be 0.9 mm.

In the present embodiment, a detection unit is provided which is a touch sensor to sense the surface of the groove 10 illustrated in FIG. 3 by utilizing a voltage drop phenomenon which occurs when a voltage is applied across the work Wo and the welding wire 211 and the welding wire 211 comes into contact with the work Wo. The detection unit is not limited to the touch sensor of the present embodiment, and an image sensor, a laser sensor, or a combination thereof may be used; however, for the sake of simplicity of the device configuration, the touch sensor in the present embodiment may be used.

### Image Capturing Device

The image capturing device 700 (hereinafter also referred to as the “visual sensor” or “camera”) is comprised of e.g., a camera including a complementary metal-oxide-semiconductor (CMOS) as a visual sensor. The placement position of the image capturing device 700 is not particularly limited. The image capturing device 700 may be directly mounted on the portable welding robot 100, or may be fixed to a specific position in the vicinity as a surveillance camera. When the image capturing device 700 is directly mounted on the portable welding robot 100, the image capturing device 700 is moved so as to capture the vicinity of the distal end of the torch 200 according to the operation of the portable welding robot 100. The number of cameras constituting the image capturing device 700 may be plural. For example, the image capturing device 700 may be constituted using multiple cameras having different functions and installation positions.

The direction in which an image is captured by the image capturing device 700 is not particularly limited. For example, when welding progresses in a forward direction, the image capturing device 700 may be disposed to capture an image on the forward side, or may be disposed to capture an image on the lateral surface side, or the rearward side. Therefore, the image capture range of the image capturing device 700 should be determined as appropriate.

Note that in order to reduce the interference with the torch 200, image capturing may be performed from the forward side, and in the present embodiment, image capturing is performed from the forward side. Captured image information is transmitted to the data processing device 800, and utilized by the data processing device 800. At this moment, the data processing device 800 may capture any image from the captured image information at e.g., a predetermined interval. The capturing method and capturing setting here may be changed, for example, according to the configuration and the function of the image capturing device 700, the performance of the data processing device 800.

In the present embodiment, the image capturing device 700 directly mounted and fixed to the portable welding robot 100 is used to capture video images as weld images to achieve an image capture range which includes at least the work Wo, the welding wire 211, and the arc as the objects (targets) to be included in the image data. Note that various image capture settings related to the weld images may be defined in advance, or may be changed according to the operation conditions of the welding system 50. The image capture settings are made for e.g., frame rate, number of pixels in image, resolution, and shutter speed.

FIG. 3 is a perspective view for explaining the placement position of the image capturing device 700 according to the present embodiment. Note that the direction of the torch 200 and the groove varies with the position of welding, so the direction illustrated in FIG. 3 is an example. In the present embodiment, the work Wo is a butt joint. The work Wo consists of two metal plates which are butted to each other with an interval of groove. In the present embodiment, horizontal position is used as an example, and in this situation, a description will be given assuming that the work on the upper plate side is denoted by W1 (hereinafter referred to as an “upper plate W1”), and the work on the lower plate side is denoted by W2 (hereinafter referred to as a “lower plate W2”). A backing material 14 made of ceramics is mounted on the rear surface side of the two works W1, W2 butted to each other. As the backing material 14, a metal-based backing material may be used, but a configuration may be adopted in which a backing material is not provided. Thus, the quality of the backing material is not limited to a specific one, and may vary depending on the quality of the work Wo. In a butt joint, arc welding is performed in one direction along the groove. Hereinafter, the direction in which welding progresses is referred to as the “weld line direction”. In FIG. 3, the direction in which welding progresses is indicated by an arrow. Thus, the torch 200 is located rearward of the image capturing device 700.

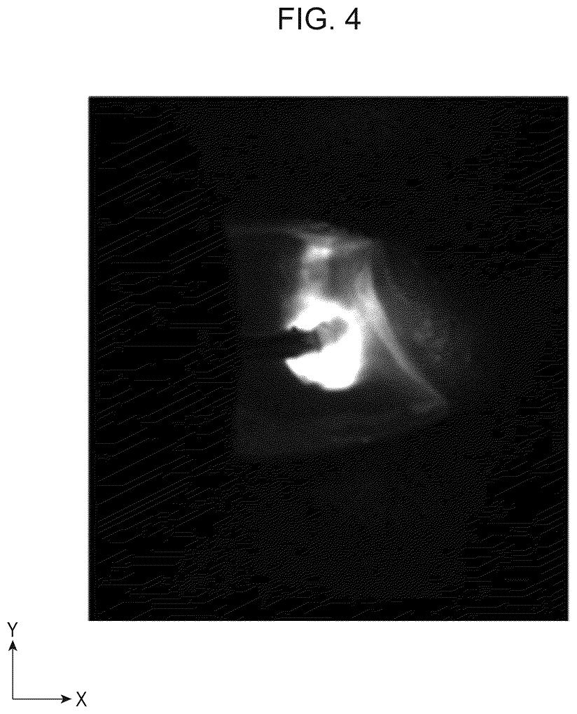

FIG. 4 is a view illustrating a weld image captured by the image capturing device 700 when horizontal position welding is performed. The image data in FIG. 4 has coordinates in a coordinate plane consisting of two axes of the X-axis and the Y-axis. In the present embodiment in which horizontal position is used, the X-axis indicates the weld line direction, and the Y-axis indicates a direction perpendicular to the X-axis. The image capturing device 700 captures an image in a range including the welding position of the work Wo during arc welding. The captured image includes a molten pool, the welding wire 211 and an arc.

The visual sensor of the image capturing device 700 in the present embodiment can continuously capture a still image of 1024×768 pixels, for example. In other words, the image capturing device 700 can capture weld images as video images. The resolution of a still image that can be captured by the image capturing device 700 is not particularly limited to a specific one. For example, when the image capturing device 700 is comprised of multiple cameras, each of the multiple cameras may obtain a weld image with a different resolution. Also, before a weld image is input to the later-described learned model, pre-processing may be performed such as clipping any feature region from the captured weld image for the purpose of reducing the processing time. Any feature region may be a fixed-size range which is arranged so that a predetermined region is located at the center. The size of any feature region may be changed according to the welding situation.

### Data Processing Device

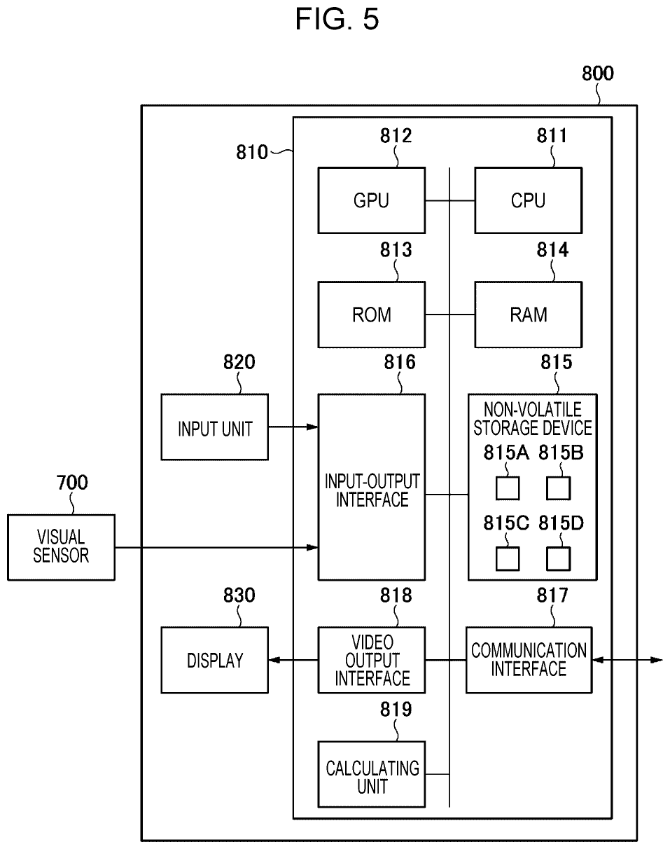

FIG. 5 is a block diagram illustrating a configuration example of the data processing device 800 according to the present embodiment. The data processing device 800 is comprised of e.g., a computer. The computer includes a body 810, an input unit 820, and a display 830. The body 810 includes a CPU 811, a graphical processing unit (GPU) 812, a ROM 813, a RAM 814, a non-volatile storage device 815, an input-output interface 816, a communication interface 817, a video output interface 818, and a calculating unit 819. The CPU 811, the GPU 812, the ROM 813, the RAM 814, the non-volatile storage device 815, the input-output interface 816, the communication interface 817, the video output interface 818, and the calculating unit 819 are communicably connected to each other via a bus or a signal line.

The non-volatile storage device 815 stores a learning program 815A that performs deep learning using predetermined learning data, a learned model 815B generated through execution of the learning program 815A, an information generation program 815C to generate welding information related to welding using the learned model 815B, and an image data 815D. In addition, an operating system and application programs are also installed in the non-volatile storage device 815.

The data processing device 800 implements various functions through execution of programs by the CPU 811 and the GPU 812. In the present embodiment, the data processing device 800 implements the function of generating a learned model by machine learning, and the function of performing various processes at the time of actual welding by utilizing the learned model. The details of these functions will be described below. Note that the data processing device 800 may be divided according to the function of generating a learned model, and the function of performing control processes based on the information output from the learned model at the time of actual welding. From the viewpoint of versatility, the data processing device 800 may be divided according to its functions. The GPU 812 is used as an arithmetic device for executing the learning program 815A and the information generation program 815C. The ROM 813 stores a basic input output system (BIOS) and the like to be executed by the CPU 811. The RAM 814 is used as a work area for a program read from the non-volatile storage device 815.

The input-output interface 816 is connected to the input unit 820 including a keyboard, a mouse and the like. The input-output interface 816 is also connected to the image capturing device 700 which is a visual sensor. The image data output from the image capturing device 700 is provided to the CPU 811 through the input-output interface 816. The communication interface 817 is a communication module for wired or wireless communication. The video output interface 818 is connected to the display 830 including e.g., a liquid crystal display or an organic electro-luminescence (EL) display, and outputs a video signal according to image data to the display 830, the image data being provided from the CPU 811. The calculating unit 819 cooperates with the CPU 811 and the GPU 812 to execute various processes such as calculation of a geometric quantity used for control of a welding speed according to the present embodiment, for example. The geometric quantity will be described below.

### Generation of Learned Model

Hereinafter, feature points extracted from image data, and a learned model that extracts feature points in the present embodiment will be described. The learned model 815B in the present embodiment is formed by a convolution neural network, and includes multiple convolution layers and multiple pooling layers. Note that the configuration of the convolution neural network is not limited to the above configuration, and the number of layers and the configuration may be those in another configuration.

The learned model 815B uses weld image output from the image capturing device 700 as input data, and outputs feature information for calculating at least the gap width, and molten pool information related to the welding progress direction. In the present embodiment, the captured image input to the learned model 815B reflects at least a molten pool, a welding wire, and an arc as objects i.e. targets. Feature points obtained from each of these objects or between multiple objects are extracted by inputting the captured image to the learned model 815B. The data processing device 800 obtains information such as the later-mentioned gap width and molten pool information as geometric quantities in real time based on the extracted feature points. Note that examples of geometric quantities of the molten pool information include the distance between the welding wire and the molten pool distal end in the weld line direction, the width of the molten pool, and the area of the molten pool. For example, the molten pool information includes at least one of the distance between a predetermined position and the molten pool distal end in the weld image, or the molten pool area. The predetermined position may be a wire distal end position or an arc center point.

In the present embodiment, as the feature points related to the welding information, the following are used: the distal end (hereinafter also referred to as the “wire distal end”) of the welding wire 211, the center point (hereinafter also referred to as the “arc center”) of the arc, the positions of the right and left (the upper and lower in the case of horizontal position) distal ends of the molten pool in the welding progress direction, and the positions of the right and left (the upper and lower in the case of horizontal position) ends of the molten pool in the welding progress direction. Input of a feature point to be used as teacher data is made by an operator specifying a specific position on the weld image according to instructions of the operation screen that supports teaching work. Thus, the teacher data is formed as pairs of a weld image and a feature point which is coordinate information as the welding information specified by an operator. In a learning process, welding information output from a learning model is compared with welding information included in the teacher data, and an error is fed back so that parameters are adjusted. Machine learning proceeds by repeating this process, thus the learned model 815B is generated.

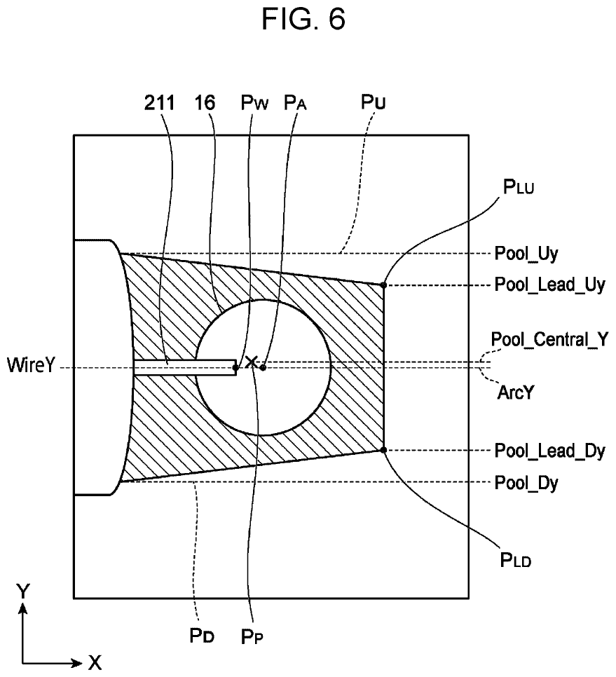

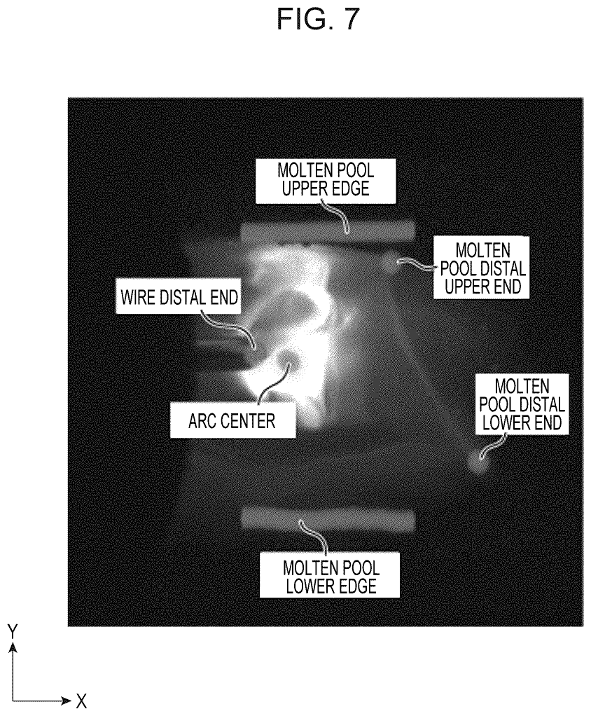

FIG. 6 is an explanatory view illustrating an example of a screen used for teaching work. The weld image on the screen illustrated in FIG. 6 includes a molten pool 15, a welding wire 211, and an arc 16. In FIG. 6, the molten pool 15 is shown by hatching. FIG. 7 is an explanatory view illustrating a specific example of a weld image obtained by horizontal position welding, and an example of welding information in the weld image. Here, to facilitate the explanation, the position corresponding the coordinates indicating a feature point is drawn and shown on the weld image. As mentioned above, the image has coordinates, thus forming a coordinate plane consisting of two axes of the X-axis and the Y-axis. Note that in the description related to FIGS. 6 and 7, the “upper end”, the “lower end” merely indicate the top and the bottom in the image, and may be replaced by the “right end”, the “left end” according to the position of welding and the direction of the image.

In the present embodiment, the image capturing device 700 is installed so that the weld line direction and the X axis direction are parallel, thus in the present embodiment, the X axis direction may be rephrased as the weld line direction. Also, the Y-axis direction is a direction perpendicular to the X-axis, in other words, the groove width direction which is a direction perpendicular to the weld line, thus the Y axis direction may be rephrased as the groove width direction. Note that the X-axis along which the portable robot of the present embodiment moves is the weld line direction, thus the X-axis along which the portable robot moves and the X-axis on the weld image are in the same direction. So, regarding the Y-axis direction, it can be stated that the Y-axis along which the portable robot moves and the Y-axis on the weld image are in the same direction.

In the present embodiment, as illustrated in FIG. 6, the following are taught as the feature points by an operator: the coordinate position PA (ArcX, ArcY) of the arc center, the coordinate position PW (WireX, WireY) of the wire distal end, the coordinate position PLD (Pool_Lead_Dx, Pool_Lead_Dy) of the molten pool distal lower end, the coordinate position PLU (Pool_Lead_Ux, Pool_Lead_Uy) of the molten pool distal upper end, the coordinate position PD (Pool_Dy) of the molten pool lower edge, and the coordinate position PU (Pool_Uy) of the molten pool upper edge.

Input of a feature point is made by an operator designating a specific position on the screen. The coordinates which provide the boundary between the welding wire 211 and the arc are an example of position coordinates of the wire distal end. The molten pool distal lower end, the molten pool distal upper end, the molten pool lower edge, and the molten pool upper edge are an example of feature points related to the behavior of the molten pool 15. For example, when the feature points, the molten pool lower edge and the molten pool upper edge are known, the width of the molten pool 15 can be calculated.

### Geometric Quantity Data

In the present embodiment, the robot control device 600 or the data processing device 800 calculates at least two values: the difference (hereinafter referred to as the “LeadX”) between the position of either predetermined molten pool distal upper end and the position of the wire distal end in the X-direction, and the difference (hereinafter referred to as the “LeadW”) between the molten pool distal upper end and the molten pool distal lower end. In the present embodiment, the numerical data calculated based on the feature points in this manner is also referred to as the “geometric quantity data”. Note that the geometric quantity data is calculated by the data processing device 800, and is transmitted to the robot control device 600 at predetermined intervals, and the robot control device 600 performs welding control. Note that regarding the molten pool distal end position, irrespective of the central position between the molten pool distal upper end and the molten pool distal lower end, the position of the molten pool distal upper end or the molten pool distal lower end may be adopted depending on the application. The robot control device 600 and the data processing device 800 may be integrated. In a range causing no contradiction, the process to be performed by the robot control device 600 may be performed by the data processing device 800 instead, and the process to be performed by the data processing device 800 may be performed by the robot control device 600 instead.

### Welding Control Method for Multi-layer Overlay Welding

Normally, deviation from the weld line and the groove width vary with location, thus in related art, the groove on the work needs to be sensed at multiple positions before welding. Therefore, the time taken for the sensing increases for a larger target work and a longer weld length. In the present invention, sensing before welding is performed only at the start point of the welding. A layer design is made based on the groove shape at the start point, and welding conditions are set based on the layer design. Welding is started with the set welding conditions, and welding of the first layer is completed by the above-mentioned process using the image capturing device 700 and the data processing device 800 during welding while performing welding condition control, weld line tracking and width tracking. Consequently, even if the work is large, the time taken for the sensing can be reduced, thus the efficiency of the weld work is improved. In the second layer, the layer design is made at positions on the weld line, and welding conditions are set based on the work information obtained from the welding of the first layer. Since conditions at each position on the weld line can be set with the work information obtained from the welding of the first layer, much time is not taken. Note that in the present invention, the position at which welding conditions are set on the weld line is referred to as the teaching position. Optimal conditions for the second layer can be set according to the work which has undergone the welding of the first layer. In other words, conditions for the second layer can be set without taking much time according to the work which has undergone deformation due to thermal distortion by the welding of the first layer.

For the second and subsequent layers, welding may be performed with the welding conditions based on the layer design made for the second layer as in the present embodiment. This is because a weld joint with stable quality can be produced by making layer design with the work information such as the gap width and tracking obtained from the welding of the first layer, thus after layer design is made for the second layer, the set conditions may be applied to the third and subsequent layers as they are. In contrast, the process using the image capturing device 700 and the data processing device 800 is also performed for the second layer, and for the third layer, a teaching position is determined again and welding conditions are set, like this, work information is obtained in each layer or each pass, and in the next layer or the next pass, layer design may be made again, and welding conditions may be set again. The details of the welding control method for multi-layer overlay welding will be described for each step below.

### Before Welding

### Step1: Sensing

In a sensing step before the start of welding, the groove shape, the thickness, the start end and the like can be identified by touch sensing using the above-mentioned touch sensor. Note that in the present embodiment, the groove shape and the thickness are identified by touch sensing at least at the welding start position only. A groove shape information calculation step is performed in which the groove shape information is calculated from detection data of the groove cross-sectional shape obtained by sensing at the welding start position. Examples of the groove shape information include e.g., groove angle of groove shape, thickness, groove depth, estimated welding metal height, and gap. After the groove shape information calculation step, a step is performed in which the calculated data is input to the holding section 601 as setting values. In the present embodiment, in the groove shape information calculation step, at least one of the thickness, groove depth, or estimated welding metal height, and the gap are calculated as the groove shape information, and are input to the holding section 601 as setting values. In the groove shape information calculation step, when the gap is smaller than the diameter of the welding wire, the gap amount may be calculated as 0.

### Step 2: Welding Condition Setting at Start Point Position

Next, setting conditions on the teaching program data are set in the layer design and each layer-each pass according to the layer design based on the data of the groove shape information input to the holding section 601 as the setting values, and a condition DB.

In other words, a program for welding for the entire weld length with the welding conditions at the start point position is once set. In the present embodiment, e.g., welding current, arc voltage, welding speed, and weaving condition are set as welding conditions. In the present embodiment, setting is made, but correction may be made. In other words, when a setting value has not been set yet, setting is made, and when a setting value has been already set, correction is made on the setting value.

### Welding of First Layer

### Step3: Welding Control of First Layer

Welding of the first layer is started with the welding conditions set at the start point position. In the present embodiment, the first layer is formed by one pass, and the first layer=one pass. As described above, along with the start of welding, image capture with the image capturing device 700 is started, weld images are input to the data processing device 800, and geometric quantity data is calculated from the weld image data, and input to the robot control device 600. In the present embodiment, the geometric quantity data output to the robot control device 600 are the above-mentioned LeadX and LeadW. The robot control device 600 with the input geometric quantity data performs welding control based on the flow in FIG. 2. Although the present embodiment illustrates an example of the first layer=one pass, the number of passes in each layer is not limited, and even if welding of the first layer consists of two or more passes, the present invention is applicable.

As illustrated in FIG. 2, the robot control device 600 receives information including the above-mentioned geometric quantity data from the data processing device 800 at predetermined intervals. The receiving is also referred to as the command reception. Upon the command reception, in the gap process S2, the robot control device 600 changes the welding conditions set at the start point position as needed according to the received geometric quantity data of the LeadW. In this manner, welding of the first layer is made possible with sensing at the start point only by changing the welding conditions based on the LeadW. In the present embodiment, the geometric quantity data of the LeadW is treated as the value of the gap in the gap process S2. Note that in the present embodiment, the unit of the value of the gap is mm, and the geometric quantity data of the LeadW in the initial layer is referred to as the “root gap”. The method of changing a welding condition according to the geometric quantity data of the LeadW is not particularly limited, and in the present embodiment, a database (hereinafter also referred to as a “torch movement DB”) that pre-defines a welding condition corresponding to the gap value is prepared for each welding mode, and the welding condition may be changed based on the torch movement DB and the received geometric quantity data of the LeadW. The welding mode herein indicates a fixed condition such as wire type, shielding gas type, angle of inclination, and pitch. The fixed condition is also referred to as the “standard item”. Note that the torch movement DB may be stored in e.g., a storage area such as the holding section 601 included in the robot control device 600.

In the torch movement process S3 in FIG. 2, the robot control device 600 determines a torch movement method based on the information received by the command reception or the information of preprocessing such as the gap process S2. The torch movement is also called weaving. In the present embodiment, the robot control device 600 determines a weaving method based on the conditions such as the offset amount, the weaving amplitude, an edge stop time (lower edge side), and an edge stop time (upper edge side) which have been determined in the gap process S2. When weaving is not included in the conditions, the torch movement process S3 is skipped, but in the present embodiment, weaving may be used for welding of the first layer. This is because the welding quality of the first layer is improved by using weaving for the initial layer, and flat shaped bead can be obtained, thus welding of the second and subsequent layers becomes more stable. Particularly, weaving has a significant effect on welding in difficult position such as horizontal position. At the time of weaving, the welding condition may be changed in each position. Specifically, the welding condition at the time of weaving may be changed (a) when moved from one edge to the other edge, (b) when located at the one edge, and (c) when located at the other edge. When horizontal position is taken as an example, a condition such as a current/voltage, an upper edge stop time, and a lower edge stop time may be changed during stop at the upper edge, during stop at the lower v, during movement from the upper edge to the lower edge, during movement from the lower edge to the upper edge.

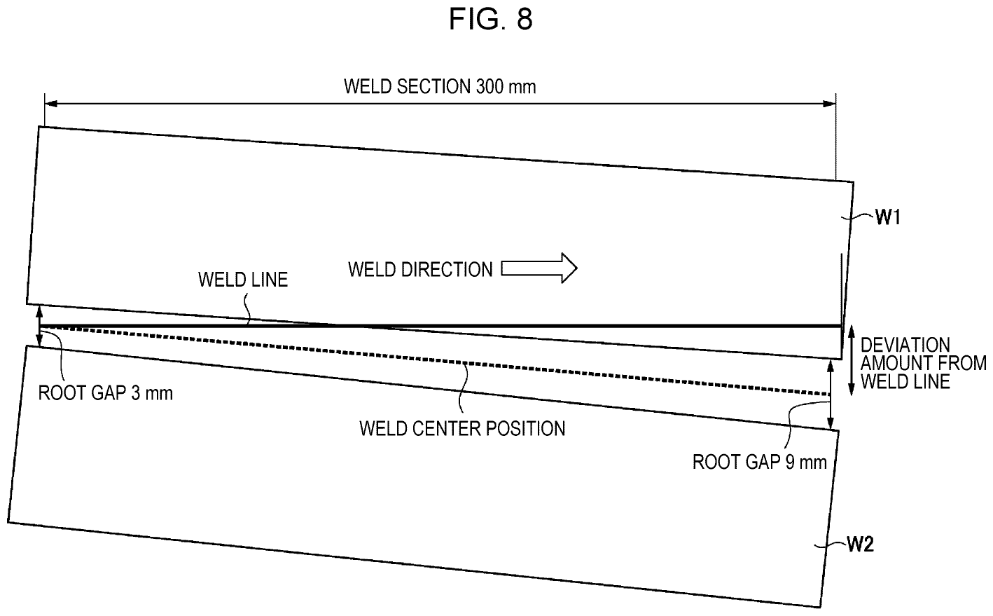

In the present embodiment, the tracking-amplitude process is performed in the tracking-amplitude process S4 illustrated in FIG. 2. In the tracking-amplitude process S4, the robot control device 600 performs weld line tracking and width tracking based on the information received by the command reception or the information of preprocessing. The tracking method is not limited, and in the present embodiment, the central position of the LeadW is set as the welding center position, and tracking control of the weld line is performed according to the deviation direction from the welding center position and the deviation amount (hereinafter also referred to as the “deviation amount from the weld line”) which are calculated based on the coordinate positions PW of the welding center position and the wire distal end. When the horizontal position in the present embodiment is taken as an example, whether deviation occurs in a lower direction or deviation occurs in an upper direction may be determined. Also, width tracking control is performed by calculating a correction amount to the amplitude according to the value of the LeadW. FIG. 8 is a conceptual view illustrating a deviation amount from a weld line according to the present embodiment.

In the present invention, the condition set according to the gap is further corrected. The accuracy of the control is further improved by the correction process, and even when various aspects such as welding condition, weaving method, welding position, root gap, backing gap and misalignment are combined, stable welding quality can be maintained. The condition to be corrected may be one of welding speed, welding current, arc voltage, or electrode extension, and from the viewpoint of the ease and accuracy of the control, at least, welding speed may be corrected. In the present embodiment, the speed process S5 is performed in FIG. 2 to correct the welding speed. In the speed process S5 illustrated in FIG. 2, correction amount to the welding speed is calculated using the value of the gap width obtained by command reception, and LeadX which is one of the molten pool information related to the welding progress direction. In the speed process S5 in the present embodiment, LeadW is used as the value of the gap width. In the present embodiment, LeadX is used as the molten pool information related to the welding progress direction, but for example, another geometric quantity data such as a molten pool area may be used.

The robot control device 600 transmits a command value to the portable welding robot 100 and the welding power source 400 according to the welding conditions changed by the above-described process. As described above, the processes in step S1 to S6 in FIG. 2 are repeated until the welding of the first layer is completed.

### After Welding of First Layer to Before Welding of Second Layer

### Step4: Determination of Teaching Point Information of Second Layer

After welding of the first layer, teaching point information on a welding point is determined based on the work information obtained at the time of welding of the first layer. Note that the teaching point information includes e.g., a teaching position (which may be simply referred to as a “teaching point”) and information of the groove cross-sectional shape at the teaching position, and determination of the teaching point information indicates addition or update of a teaching position and groove cross-sectional shape information at a teaching position.

In the present embodiment, the work information obtained at the time of welding of the first layer includes the value (the value of LeadW) of the gap width over the entire length of welding and the deviation amount from the weld line. Teaching point information is determined based on the value of the gap width or the deviation amount from the weld line, or both of these.

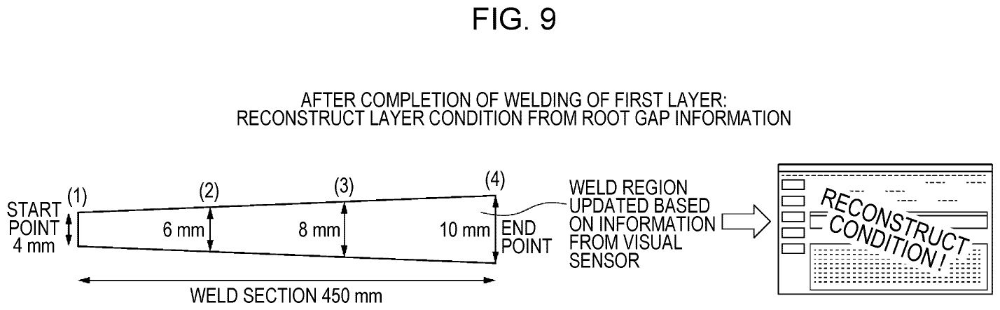

For example, determination of a teaching position and groove cross-sectional shape at a teaching position which are teaching point information is made at the welding start position and the welding end position and by adding or updating the teaching point information at each position where the gap width or the deviation amount from the weld line changes by a predetermined incremental length. For example, when welding with a varying gap width is performed, the teaching position and the groove cross-sectional shape at the teaching position are at least added or updated at each position where the gap width changes by a predetermined incremental length from the gap width at the start point position. FIG. 9 is a conceptual view illustrating a method of addition or update of a teaching position according to the present embodiment. In FIG. 9, for example, when the gap width incrementally changes by 2 mm, the teaching position and the groove cross-sectional shape at the teaching position are added or updated, and the positions for 4 mm, 6 mm, 8 mm, 10 mm are added or updated as the teaching positions, and the groove cross-sectional shape is added or updated at each teaching position.

As an appropriate method for determining teaching point information, a method of determining teaching point information based on both the value of the gap width and the deviation amount from the weld line every weaving half cycle or every control cycle of the robot may be used.

### Step5: Condition Setting for Second Layer

Layer design is made by referring to the condition DB based on the groove shape information at each teaching position of the second layer obtained in STEP4. Layer design is made at each teaching point based on the gap width at each teaching position obtained at the time of welding of the first layer, and the groove shape information other than the gap width obtained at the time of start point sensing, and conditions may be set based on the layer design.

In the present embodiment, layer design information (hereinafter also referred to as “reference layer design information”) of the gap width serving as a reference is pre-stored in the condition DB. The robot control device 600 easily calculates the cross-sectional area per pass at each teaching position based on the reference layer design information, and determines the welding conditions from the cross-sectional area. For example, when occurrence of a variation of 4 to 10 mm in the gap width can be predicted due to the property of the work to be welded, layer design of a gap width of 7 mm as the median is prepared in advance, and the cross-sectional area per pass is calculated at each teaching position obtained from the layer design (the number of layers-the number of passes) of a gap width of 7 mm to set welding conditions. At this point, when the gap width is 10 mm, the cross-sectional area per pass at a teaching position is (10 mm/7 mm) times the cross-sectional area of each pass in the reference layer design information, and when the gap width is 4 mm, the above calculation is performed with (4 mm/7 mm) times so that the cross-sectional area per pass should be easily calculated. In this manner, welding conditions at multiple teaching positions can be easily set using one piece of layer design information as a predetermined reference, thus the load accompanying the calculation process can be significantly reduced.

### Step6: Welding of Second and Subsequent Layers

In the present embodiment, the passes of the second and subsequent layers are welded with the welding conditions based on the layer design generated at each teaching point. The process using the image capturing device 700 and the data processing device 800 is also performed for the second and subsequent passes, and for the next layer, a teaching position is determined again and conditions are set, like this, work information is obtained in each layer or each pass, and in the next layer or the next pass, layer design may be made again, and welding conditions may be set again. Specifically, for the second and subsequent layers, the teaching point information, the welding conditions in the teaching point information, and at least one of layer patterns in the teaching point information for the (n+1)th layer may be determined before welding of the (n+1)th layer based on the work information obtained by control in the welding of the nth layer (n is a natural number greater than 1).

Due to the above steps, significant reduction of the welding work time and welding of the second and subsequent layers with optimal conditions can be made possible by performing control for multi-layer overlay welding, thus favorable welding quality can be obtained.

### Selection of Welding Material

In the present invention, all layers may be welded with the same welding material, or the welding material may be changed for each layer. The welding material to be used is selected from at least a slag type flux-cored wire, a metal-cored wire, and a solid wire. When all layers are welded with the same welding material, from the viewpoint of welding workability, welding may be performed with one of a slag type flux-cored wire, a metal-cored wire, or a solid wire. When the welding material is changed for each layer, the initial layer or layers up to the nth layer (n is a natural number selected from integers greater than 1) are welded with the same welding material, and the (n+1)th and subsequent layers should be welded with another welding material different from the welding material used for layers up to the nth layer. Specifically, for the initial layer or layers up to the second layer for which welding is difficult, a favorable bead shape can be obtained by performing welding with a slag type flux-cored wire or a metal-cored wire. Meanwhile, for the third and subsequent layers, a favorable bead shape can be obtained by changing the welding material to a solid wire.

Note that the present invention is not limited to the above embodiment, and modifications and applications made by those skilled in the art based on mutual combinations of the components of the embodiment, the description of the specification, and well-known techniques are contemplated by the present invention, and included in the range of protection of the present invention.

As described above, the following matters are disclosed in the present specification.
(1) A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device; and
determining, after the welding of the first layer, teaching point information for second and subsequent layers before welding of the second layer based on work information obtained by control in the welding of the first layer.
(2) The welding control method according to (1),
wherein weaving is performed during the welding of the first layer, and
the welding control method comprises changing a welding condition for weaving at least when moved from one end to the other end, when located at the one end, and when located at the other end.
(3) The welding control method according to (2),
wherein the welding condition in the weaving is determined from a preset DB based on geometric quantity data or work information obtained during welding.
(4) The welding control method according to (1),
wherein the work information is one of at least a gap and a deviation amount from a weld line.
(5) The welding control method according to any one of (1) to (4),
wherein a welding material is selected from one of at least a solid wire, a slag type flux-cored wire, and a metal-cored wire,
let n be a natural number selected from integers greater than 1,
an initial layer or layers up to nth layer are welded with a same welding material,
(n+1)th and subsequent layers are welded with another welding material different from the welding material used for up to the nth layer.
(6) the welding control method according to any one of (1) to (4),
wherein a welding material is selected from one of at least a solid wire, a slag type flux-cored wire, and a metal-cored wire, and
all layers are welded with a same welding material.
(7) A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device;
determining, after the welding of the first layer, teaching point information for a second layer before welding of the second layer based on work information obtained by control in the welding of the first layer; and
determining, for the second and subsequent layers, before welding of (n+1)th layer, at least one of teaching point information of the (n+1)th layer, a welding condition in the teaching point information, or a layer pattern in the teaching point information based on work information obtained by control in welding of nth layer, the n being a natural number greater than 1.
(8) A welding system for performing multi-layer overlay welding, comprising at least a welding robot, a robot control device that controls the welding robot, a camera, and a data processing device that processes image data obtained from the camera,
wherein the welding robot determines, before welding, welding conditions at any position on a welding start side on a workpiece, and
starts welding of a first layer based on the welding conditions,
the data processing device receives input of image data obtained from the camera during welding of the first layer, and outputs a feature value of the image data to the robot control device,
the robot control device controls at least one of the welding conditions based on the feature value, and
the robot control device determines, after the welding of the first layer, teaching point information for second and subsequent layers before welding of the second layer based on work information obtained by control in the welding of the first layer.
(9) A welding control program for multi-layer overlay welding causing a robot control device for controlling a welding robot to execute a process comprising:
causing the welding robot to weld a first layer based on welding conditions determined at any position on a welding start side on a workpiece before welding;
controlling at least one of the welding conditions based on a feature value of image data, obtained based on the image data obtained from a camera during the welding of the first layer, the image data including a molten pool, a welding wire and an arc; and
determining, after the welding of the first layer, teaching point information for second and subsequent layers before welding of the second layer based on work information obtained by control in the welding of the first layer.
(10) A multi-layer overlay welding method performed using a welding system including at least a welding robot, a robot control device that controls the welding robot, a camera, and a data processing device that processes image data obtained from the camera, the multi-layer overlay welding method comprising:
determining, before welding, welding conditions at any position on a welding start side on a workpiece;
starting welding of the first layer based on the welding conditions, and controlling at least one of the welding conditions based on a feature value of image data, obtained based on the image data obtained from the camera during the welding of the first layer, the image data including a molten pool, a welding wire and an arc; and
determining, after the welding of the first layer, teaching point information for second and subsequent layers before welding of the second layer based on work information obtained by control in the welding of the first layer.

1. A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device; and
determining, after the welding of the first layer, teaching point information for second and subsequent layers before welding of the second layer based on work information obtained by control in the welding of the first layer.

2. The welding control method according to claim 1,
wherein weaving is performed during the welding of the first layer, and
the welding control method comprises changing a welding condition for weaving at least when moved from one end to the other end, when located at the one end, and when located at the other end.

3. The welding control method according to claim 2,
wherein the welding condition in the weaving is determined from a preset DB based on geometric quantity data or work information obtained during welding.

4. The welding control method according to claim 1,
wherein the work information is one of at least a gap and a deviation amount from a weld line.

5. The welding control method according to claim 1,
wherein a welding material is selected from one of at least a solid wire, a slag type flux-cored wire, and a metal-cored wire,
let n be a natural number selected from integers greater than 1,
an initial layer or layers up to nth layer are welded with a same welding material,
(n+1)th and subsequent layers are welded with another welding material different from the welding material used for up to the nth layer.

6. The welding control method according to claim 1,
wherein a welding material is selected from one of at least a solid wire, a slag type flux-cored wire, and a metal-cored wire, and
all layers are welded with a same welding material.

7. A welding control method for multi-layer overlay welding performed using a welding system including at least a welding robot, a robot control device that controls the welding robot, a camera, and a data processing device that processes image data obtained from the camera, the welding control method comprising:
determining, before welding, welding conditions at any position on a welding start side on a workpiece using the welding robot;
starting welding of a first layer based on the welding conditions, receiving input of the image data obtained from the camera by the data processing device during welding of the first layer, outputting a feature value of the image data to the robot control device, and controlling at least one of the welding conditions based on the feature value by the robot control device;
determining, after the welding of the first layer, teaching point information for a second layer before welding of the second layer based on work information obtained by control in the welding of the first layer; and
determining, for the second and subsequent layers, before welding of (n+1)th layer, at least one of teaching point information of the (n+1)th layer, a welding condition in the teaching point information, or a layer pattern in the teaching point information based on work information obtained by control in welding of nth layer, the n being a natural number greater than 1.

8. A welding system for performing multi-layer overlay welding, comprising at least a welding robot, a robot control device that controls the welding robot, a camera, and a data processing device that processes image data obtained from the camera,
wherein the welding robot determines, before welding, welding conditions at any position on a welding start side on a workpiece, and
starts welding of a first layer based on the welding conditions,
the data processing device receives input of image data obtained from the camera during welding of the first layer, and outputs a feature value of the image data to the robot control device,
the robot control device controls at least one of the welding conditions based on the feature value, and
the robot control device determines, after the welding of the first layer, teaching point information for second and subsequent layers before welding of the second layer based on work information obtained by control in the welding of the first layer.

9. A non-transitory computer readable medium storing a welding control program for multi-layer overlay welding causing a robot control device for controlling a welding robot to execute a process comprising:
causing the welding robot to weld a first layer based on welding conditions determined at any position on a welding start side on a workpiece before welding;
controlling at least one of the welding conditions based on a feature value of image data, obtained based on the image data obtained from a camera during the welding of the first layer, the image data including a molten pool, a welding wire and an arc; and
determining, after the welding of the first layer, teaching point information for second and subsequent layers before welding of the second layer based on work information obtained by control in the welding of the first layer.

10. A multi-layer overlay welding method performed using a welding system including at least a welding robot, a robot control device that controls the welding robot, a camera, and a data processing device that processes image data obtained from the camera, the multi-layer overlay welding method comprising:
determining, before welding, welding conditions at any position on a welding start side on a workpiece;
starting welding of the first layer based on the welding conditions, and controlling at least one of the welding conditions based on a feature value of image data, obtained based on the image data obtained from the camera during the welding of the first layer, the image data including a molten pool, a welding wire and an arc; and
determining, after the welding of the first layer, teaching point information for second and subsequent layers before welding of the second layer based on work information obtained by control in the welding of the first layer.
